(19) United States
(12) Patent Application Publication
(10) Pub. No.: US 2022/0379438 A1
(43) Pub. Date: Dec. 1, 2022

(54) CLAMPING DEVICE

(71) Applicant: DESTACO EUROPE GMBH, Oberursel (DE)

(72) Inventor: Markus RAMGE, Bickenbach (DE)

(21) Appl. No.: 17/634,965

(22) PCT Filed: Aug. 5, 2020
(86) PCT No.: PCT/DE2020/100690

§ 371 Date: Feb. 12, 2022

(30) Foreign Application Priority Data
Aug. 14, 2019 (DE) 10 2019 121 860.8

(51) Int. Cl. B25B 5/08

(52) U.S. Cl. CPC B25B 5/08

(57) ABSTRACT

A clamping device has a clamping member (2) moveably mounted in a main body 1. A linearly movable actuator (3) is operatively connected to the clamping member (2). A spring element (4) is operatively connected to the actuator (3). A rotatably mounted actuating element (5) is operatively connected to the spring element (4). The spring element (4) is a compression spring that can be compressed when tensioning by the actuating element (5).

### FIELD

The disclosure relates to a clamping device with a clamping member moveably mounted in a main body. A linearly movable actuator is operatively connected to the clamping member. A spring element is operatively connected to the actuator. Also, a rotatably mounted actuating element operatively connected to the spring element. The spring element is formed as a compression spring that can be compressed during clamping by the actuating element.

### BACKGROUND

A clamping device of the type mentioned at the outset is known from patent document DE 10 2016 200 180 A1. It has a clamping member that is movably mounted in a main body. A linearly movable actuator is operatively connected to the clamping member. A spring element is operatively connected to the actuator. A rotatably mounted actuating element is operatively connected to the spring element. In this solution, the spring element is formed as an extension spring (reference numeral 24 in this document) on account of the grooved plate (reference numeral 19 in this document).

### SUMMARY

The object of the disclosure is to improve a clamping device of the type mentioned at the outset. In particular, the operation of such a clamping device is intended to be improved in the event that the spring element fails.

The object is achieved by a clamping device of the type mentioned at the outset with the following features. A clamping member that is moveably mounted in a main body. A linearly movable actuator is operatively connected to the clamping member. A spring element is operatively connected to the actuator. Also, a rotatably mounted actuating element operatively connects to the spring element. The spring element is formed as a compression spring that can be compressed during clamping by the actuating element.

According to the disclosure, the spring element is formed as a compression spring. It can be compressed during clamping by the actuating element.

In other words, the solution according to the disclosure utilizes compression spring instead of the extension spring. This has far-reaching consequences and advantages, especially in connection with other developments, that will be discussed in more detail below.

Other advantageous developments of the clamping device according to the disclosure can be found in the dependent claims.

### DRAWINGS

The clamping device according to the disclosure and its advantageous developments according to the dependent claims will be explained in more detail in the following on the basis of the graphic representation of a preferred embodiment.

FIG. 1 is a sectional view of the clamping device in the open position;

FIG. 2 is a sectional view of the clamping device according to FIG. 1 on its way into the closed position;

FIG. 3 is a sectional view of the clamping device according to FIG. 1 in the closed position when the spring element is placed under a large amount of load;

FIG. 4 is a sectional view of the clamping device according to FIG. 1 in the closed position when the spring element is placed under a small amount of load;

FIG. 5 is a sectional view from the side of the clamping device according to FIG. 4;

FIG. 6 is a first perspective view of the clamping device according to FIG. 1 in the closed position;

FIG. 7 is a second perspective view of the clamping device according to FIG. 1 in the closed position;

FIG. 8 is a first lateral sectional view of the loaded spring element according to FIG. 4;

FIG. 9 is a second lateral sectional view of the loaded spring element according to FIG. 4;

FIG. 10 is a lateral view of a housing portion of the clamping device, where a latching mechanism is arranged;

FIG. 11 is a transparent perspective view of the housing portion that houses the latching mechanism;

FIG. 12 is an exploded perspective view of the latching mechanism; and

FIG. 13 is a sectional view of the housing portion, that houses a movement mechanism and the latching mechanism and on which the actuating element is arranged.

### DETAILED DESCRIPTION

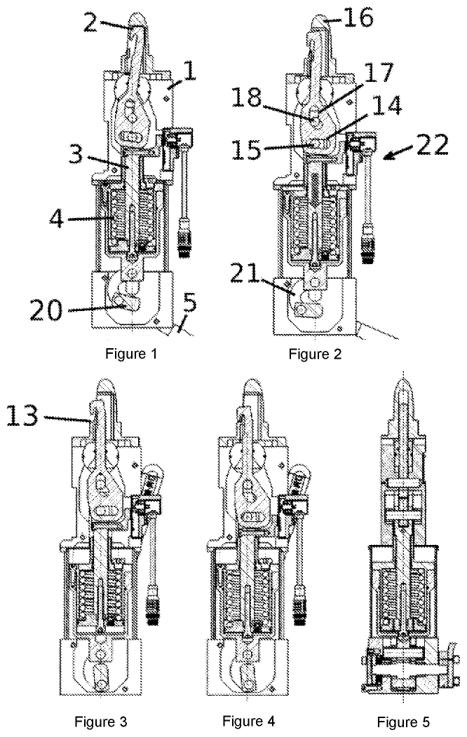

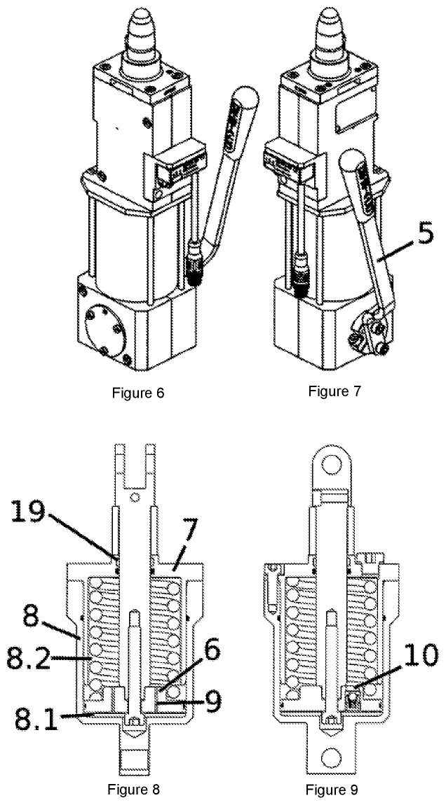

The clamping device shown in the drawings has a clamping member 2, that is movably mounted in a main body 1, a linearly movable actuator 3, that is operatively connected to the clamping member 2, a spring element 4, that is operatively connected to the actuator 3 and a rotatably mounted actuating element 5, that is operatively connected to the spring element 4. See in particular, FIG. 1.

In this case, the clamping member 2 is formed as a clamping hook. A counter bearing 13 is provided on the main body 1 for the clamping hook. A centering pin 16 is provided on the main body 1 and the clamping member 2 is arranged in the centering pin 16, at least in part.

It is now essential for the clamping device according to the disclosure for the spring element 4 to be formed as a compression spring that can be compressed during clamping by the actuating element 5.

The clamping member 2 is pivotably and movably mounted in the main body 1. Likewise, a guide slot 14 is provided at the end of the clamping member 2 on the actuator side. A pin 15 engages the guide slot 14. The pin 14 is provided at the end of the actuator 3 on the side of the clamping member. In addition, a curved guide slot 17 is provided on the clamping member 2. A guide pin 18 engages the curved guide 17. The guide pin 18 is provided on the main body 1. See, in particular, FIG. 2.

In addition, an abutment element 6, for the spring element 4, is arranged at the end of the actuator 3 that faces away from the clamping member 2. In this case, the spring element 4 is formed as a helical compression spring. The abutment element 6 is disc-shaped. In addition, it is preferable for the actuator 3 to be centrally arranged on the abutment element 6. The spring element 4 is arranged concentrically with the actuator 3 on the abutment element 6. The spring element 4 is supported on the actuator 3 on one side and on an abutment 7, operatively connected to the actuating element 5, on the other side. Furthermore, the abutment 7 is arranged at one end of a housing 8, which is pot-shaped. The actuating element 5 is operatively connected to the other end of the housing 8. The abutment 7 is formed as a cover for the pot-shaped housing 8. A through-hole 19 is provided in the cover for the actuator 3. In addition, the abutment element 6 is mounted in the housing 8. The abutment element 6 is in the form of a piston in order to form a damper and/or for the housing 8 to be movably mounted in the main body 1.

A channel 9 is arranged on the abutment element 6, the rest of which is sealingly guided in the housing 8. See, in particular, FIG. 8. In addition, a check valve 10 is arranged on the abutment element 6. The rest of the element is sealingly guided in the housing 8 with the exception of the channel 9. See, in particular, FIG. 9. In addition, both the channel 9 and the check valve 10 are each provided to fluidically connect two chambers 8.1, 8.2 arranged on either side of the abutment element 6. In this case, the housing 8, the chambers 8.1, 8.2, is/are preferably filled with a damping medium, preferably oil. In this case, it is preferable for the channel 9 to be dimensioned in a manner that prevents the spring element 4 from rapidly expanding and/or for the check valve 10 to be open during a movement of the abutment element 6 relative to the abutment 7 that causes the spring element 4 to compress. Also, the check valve is closed during a movement of the abutment element 6 relative to the abutment 7 that causes the spring element 4 to expand.

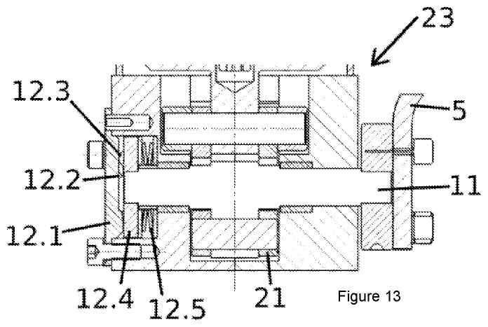

Furthermore, a rotary shaft 11 is rotatably mounted on the main body 1. The shaft 11 provides for rotatably mounting the actuating element 5. A lever arm 20 is arranged on the rotary shaft 11. An intermediate member 21 is hingedly mounted on the lever arm 20. In this case, the intermediate member 21 is hingedly connected to the housing 8. The rotary shaft 11, the lever arm 20 and the intermediate member 21 thereby preferably form (see FIG. 13) a movement mechanism 23.

In addition, it is preferable for the intermediate member 21 to be U-shaped and to surround the rotary shaft 11 in the clamped position. Likewise, the intermediate member 21 is preferably formed as part of a toggle lever device.

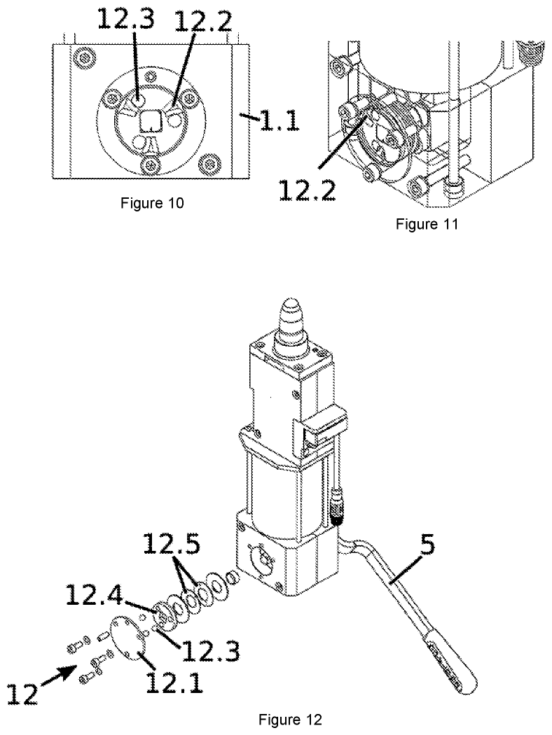

In addition, a latching mechanism 12 that holds the clamping device in the open position is provided on the rotary shaft 11, which is mounted in the housing portion 1.1. In this case, the latching mechanism 12 includes a plate 12.1, that is fastened to the main body 1, and a latching projection 12.2. A ball 12.3, interacts with the latching projection 12.2. A support plate 12.4 for the ball 12.3, is moveably connected to the rotary shaft 11 to rotate conjointly with it. A spring apparatus pushes the ball 12.3 against the plate 12.1. Furthermore, the spring apparatus is formed from at least one disc spring 12.5. See, in particular FIGS. 10 to 13. As becomes clear to a person skilled in the art from the present technical framework conditions, at least one latching projection 12.2 and at least one ball 12.3 must be provided in all cases. However, two, or particularly preferably even three, latching projections 12.2 and balls 12.3 are distributed across the circumference.

Lastly, an end position interrogation apparatus 22 interacts with the actuator 3 and preferably operates inductively. The interrogation apparatus 22 is arranged on the main body 1.

According to the embodiment shown in the drawings, the clamping device operates as follows:

The clamping device is firstly in an open position (see FIG. 1). The entire clamping member 2 is arranged in the centering pin 16 and the lever arm 20 is arranged in an upper or lateral position. In this state, the clamping device is held open, since the ball 12.3 of the latching mechanism 12 is blocked by the latching projection 12.2. Undesirable movement of the actuating element 5 by itself and therefore shifting of the intermediate member 21 is ruled out.

In order to bring the clamping device into the clamping position, the lever arm 20 is rotated downward by the actuating element 5. This moves the ball 12.3 past the latching projection 12.2 against resistance. As a result, the housing 8 is pulled downward in the main body 1 by the intermediate member 21. The actuator 3 is moved downward. The downward movement of the actuator 3 causes a downward movement of the clamping member 2 as a result of the actuator 3 and the clamping member 2 coupled by the guide slot 14 and the pin 15. This downward movement occurs at the same time as a pivot movement of the clamping member 2. The pivot arrangement is caused by the guide pin 18 traveling in the curved guide 17. The superposition of these two movements causes the clamping member 2 to leave the centering pin 16 to move in the direction of the counter bearing 13 to clamp a workpiece. The fact that the lever arm 20 and the intermediate member 21 are formed as part of a toggle lever device (movement mechanism 23) and the toggle lever is in an over-center position when the clamping device is in the clamped position ensures that the clamped position cannot loosen by itself. Together with the above-mentioned latching mechanism 12, this allows for operation of the clamping device.

Should the clamping member 2 reach the workpiece, it cannot be pulled downward any further. The same also applies to the actuator 3 connected to the clamping member 2 and to the abutment element 6, connected to the actuator. The housing 8 together with the abutment 7 can, however, be lowered a little bit further when the lever arm 20 moves. Since the spring element 4 is positioned between the abutment element 6 and the abutment 7, the spring element 4 is compressed (cf. FIGS. 2 and 3). The resultant spring force counteracts undesirable opening of the clamping device and results in operating the clamping device. In addition, this ensures that the clamping position is maintained even if the spring element 4 fails. Furthermore, filling the chambers 8.1 and 8.2 of the housing 8 with a damping medium, as described above, is advantageous, since abrupt movements of the actuator 3 and, in particular, of the actuating element 5 arranged on the outside of the clamping device are damped or prevented.

The spring force exerted by the spring element 4 is greater when clamping thicker workpieces than thinner ones. Thus, the spring element 4 is more greatly compressed in this case (cf. FIGS. 3 and 4). In this case, the flexible compression of the spring element 4 enables for a certain degree of tolerance compensation (which is very advantageous) in terms of the thickness of the workpiece while still providing sufficient clamping force in the event of very thin workpieces.

Another advantage of the clamping device according to the disclosure is, by using a compression spring as the spring element 4, an installation space is required for the spring element is smaller than in similar structures using an extension spring, while providing the same (high) clamping force.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-10. (canceled)

11. A clamping device, comprising:
a clamping member, moveably mounted in a main body;
a linearly movable actuator operatively connected to the clamping member;
a spring element operatively connected to the actuator;
a rotatably mounted actuating element operatively connected to the spring element; and
the spring element is formed as a compression spring that can be compressed during clamping by the actuating element.

12. The clamping device according to claim 11, further comprising an abutment element for the spring element arranged at the end of the actuator and faces away from the clamping member.

13. The clamping device according to claim 12, wherein the spring element supported on the actuator on one side and supported on an abutment operatively connected to the actuating element, on the other side.

14. The clamping device according to claim 13, wherein the abutment is arranged at one end of a housing and the actuating element is operatively connected to the other end of the housing.

15. The clamping device according to claim 14 wherein the abutment element is mounted in the housing in the form of a piston to form a damper.

16. The clamping device according to claim 14 wherein the housing is movably mounted in the main body.

17. The clamping device according to claim 15 wherein a channel is arranged on the abutment element, the rest of which element is sealingly guided in the housing.

18. The clamping device according to claim 17, further comprising a check valve arranged on the abutment element, the rest of which is sealingly guided in the housing with the exception of the channel.

19. The clamping device according to claim 18, wherein the check valve is open during a movement of the abutment element that causes the spring element to compress, and is closed during a movement of the abutment element that causes the spring element to expand.

20. The clamping device according to claim 11 further comprising a rotary shaft rotatably mounted on the main body for rotatably mounting the actuating element and a latching mechanism on the rotary shaft holding the clamping device in an open position.

21. The clamping device according to claim 16 wherein a channel is arranged on the abutment element, the rest of which element is sealingly guided in the housing.
